(19) United States
(12) Patent Application Publication
(10) Pub. No.: US 2015/0029767 A1
(43) Pub. Date: Jan. 29, 2015

(54) Power Controllers with Ultra-High-Voltage Startup

(71) Applicant: Leadtrend Technology Corporation, Hsinchu (TW)

(72) Inventor: Chiung-Feng Chou, Hsinchu (TW)

(21) Appl. No.: 14/333,425

(22) Filed: Jul. 16, 2014

(30) Foreign Application Priority Data
Jul. 29, 2013 (TW) 102127029

(51) Int. Cl. H02M 7/00; H02M 1/36

(52) U.S. Cl. CPC H02M 7/003; H02M 1/36
USPC 363/49

(57) ABSTRACT

A power controller in a multi-chip module is disclosed. The power controller comprises a power controller die, an ultra-high voltage startup die, and a multi-chip module. The power controller die is operable to control a power switch when powered by an operation power source. The operation power source has a maximum voltage limit of tens volt. The ultra-high voltage startup die comprises an ultra-high voltage pad tolerable to receiving an input line voltage higher than one hundred volt. During a startup procedure the ultra-high voltage startup die charges the operation power source, and during a normal operation the ultra-high voltage startup die substantially performs an open-circuit. The multi-chip module packages both the power controller die and the ultra-high voltage startup die.

### CROSS-REFERENCE TO RELATED APPLICATION

This application claims priority to and the benefit of Taiwan Application Series Number 102127029 filed on Jul. 29, 1013, which is incorporated by reference in its entirety.

### BACKGROUND

The present disclosure relates generally to power controllers suitable for switching mode power supplies, more particularly, to power controllers with ultra-high voltage startup.

A switching mode power supply normally employs at least one power switch to manipulate the current through an inductive device. In comparison with other kinds of power supplies, switching mode power supplies enjoy compact product size and excellent power conversion rate, and accordingly are popular and welcome in the field of power supply manufacturing.

FIG. 1 demonstrates a conventional switching mode power supply 8. Power controller 14, which is an integrated circuit individually packaged, controls a power switch 10 to be open-circuit or closed-circuit, thereby controlling the current flowing through the primary winding 16. Input power source V_{IN}, which might be generated by using a bridge rectifier to rectify the alternative-current (AC) mains voltage from a power plug, could be as high as 500 volt. Based on the terminology in the art, here in this specification, high voltage refers to as the voltage with ten to tens volt, and ultra-high voltage refers to as the voltage with more than one hundred volt. When input power source V_{IN} just happens, such as at the moment when switching mode power supply 8 is just connected to AC mains voltage, ultra-high voltage startup circuit 12, which is another integrated circuit individually packaged, starts charging capacitor 18 to build up operation power source V_{CC}. Only when the operation power source V_{CC} is high enough in volt, the ultra-high voltage startup circuit 12 then stops the charging. Before the charging is stopped, power controller 14 could start manipulating the current flowing through the primary winding 16, causing an auxiliary winding 20 to generate current and charge the capacitor 18.

Simply put, ultra-high voltage startup circuit 12, as it is named, works only during a startup procedure for roughly building up the operation power source V_{CC}. After that startup procedure, power controller 14 normally turns on and off the power switch 10, and ultra-high voltage startup circuit 12 is OFF to substantially perform as an open-circuit, which consumes no current or electrical energy.

FIG. 2 demonstrates another switching mode power supply, where power controller 22 alone performs ultra-high voltage startup and the control of the power switching 10. Simply speaking, power controller 22 is a single integrated circuit package, in which only one semiconductor die is packaged while it implements the functions of both the power controller 14 and the ultra-high voltage startup circuit 12.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified. These drawings are not necessarily drawn to scale. Likewise, the relative sizes of elements illustrated by the drawings may differ from the relative sizes depicted.

The invention can be more fully understood by the subsequent detailed description and examples with references made to the accompanying drawings, wherein:

FIG. 1 demonstrates a conventional switching mode power supply;

FIG. 2 demonstrates another switching mode power supply;

FIG. 3 demonstrates a power controller according to embodiments of the invention;

FIG. 4 demonstrates some circuits in the ultra-high voltage startup die and the PWM controller die of FIG. 3;

FIG. 5 demonstrates another power controller according to embodiments of the invention;

FIG. 6 shows a power controller, which is a chip-stack package; and

FIG. 7 demonstrates a power controller in an embodiment of the invention.

### DETAILED DESCRIPTION

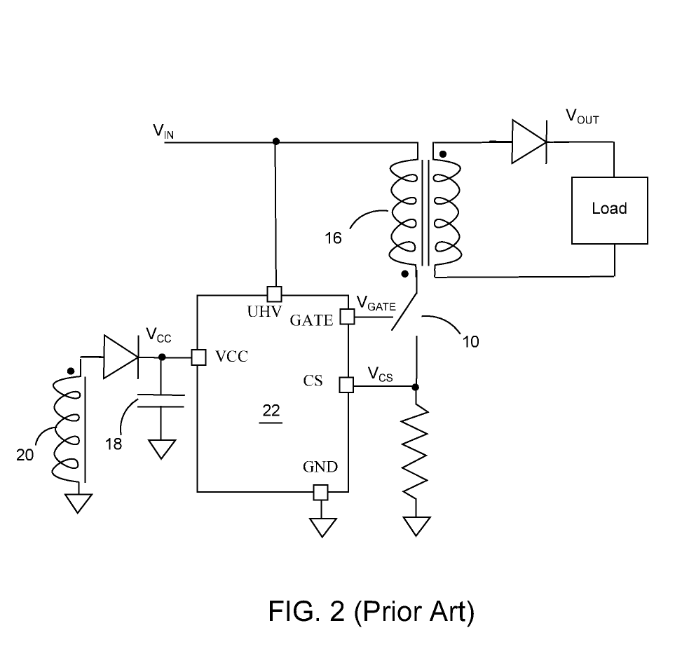

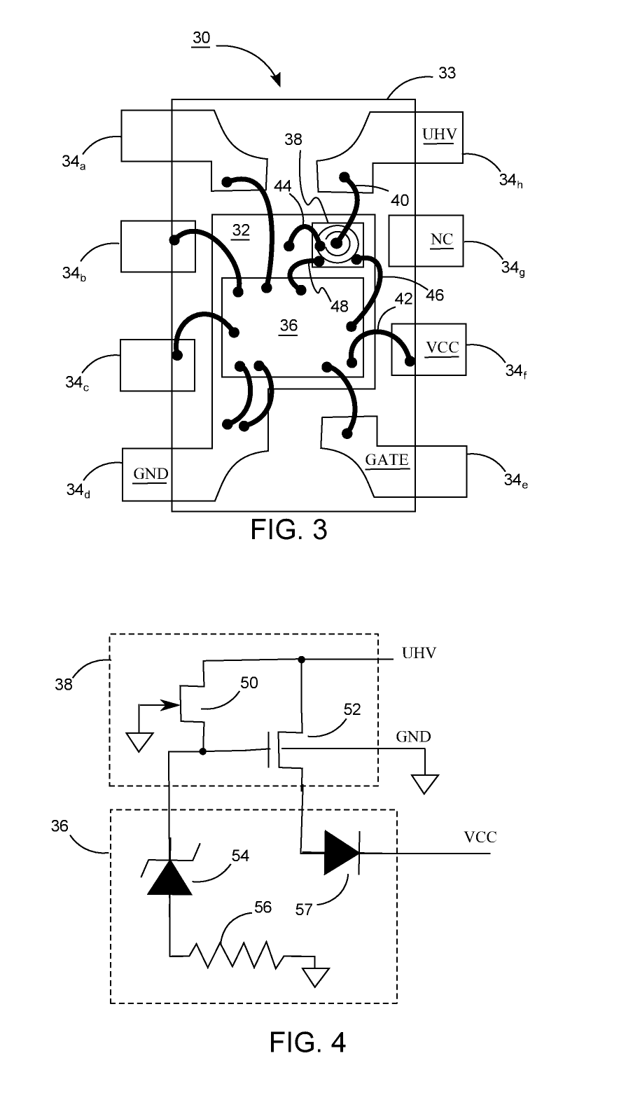

FIG. 3 demonstrates a power controller 30 according to embodiments of the invention. In one embodiment, the power controller 30 replaces the power controller 22 in FIG. 2.

Separately positioned inside the power controller 30 are a PWM controller die 36 and an ultra-high voltage startup die 38, packaged together inside a multi-chip module 33, which has a leadframe with a die paddle 32 and leads 34ₐ˜34ₕ. The PWM controller die 36 and the ultra-high voltage startup die 38 could be fixed on the die paddle 32, using conductive glue such as silver paste. The lead 34_{d} extends to connect with the die paddle 32, and acts as a ground pin GND. PWM controller die 36 could send PWM signal to pin GATE for turning on or off an external power switch, such as the power switch 10 in FIG. 2.

In one embodiment, the maximum input voltage limit of the ultra-high voltage startup die 38 that does not cause damage is at least 500V, and that of the PWM controller die 36 is at least 40V. More specifically, the maximum voltage limit at pin UHV that causes no harm to the ultra-high voltage startup die 38 is at least 500V, and that maximum voltage limit at pin VCC that causes no harm to the PWM controller die 36 is at least 40V.

The ultra-high voltage startup die 38 is positioned in one corner of the die paddle 32, which is the closest to lead 34ₕ, and away from the other corners. The lead 34ₕ is also referred to as the ultra-high voltage input pin UHV. In FIG. 3, leads 34ₐ, 34_{d}, and 34ₕ are referred to in this specification as corner leads because that their locations are in corners of a leadframe. One end of the bonding wire 40 is on the lead 34ₕ (or pin UHV), and the other end on an ultra-high voltage pad, which locates in a central portion of the ultra-high voltage startup die 38 and is tolerable to receiving an input line voltage higher than 500v. The bonding wire 46 electrically connects a charging pad of the ultra-high voltage startup die 38 to the PWM controller die 36. The bonding wire 44 electrically connects a ground pad of the ultra-high voltage startup die 38 to the die paddle 32, in order to provide a ground voltage to the ultra-high voltage startup die 38. The bonding wire 48 connects a control pad in the ultra-high voltage startup die 38 to the PWM controller die 36, which accordingly controls the ultra-high voltage startup die 38. Shown in FIG. 3, the ultra-high voltage startup die 38 has only four kinds of pads, consisting of ultra-high voltage pad, charging pad, ground pad, and control pad.

FIG. 4 demonstrates some circuits in the ultra-high voltage startup die 38 and the PWM controller die 36. In one embodiment, the ultra-high voltage startup die 38 has only two active devices, JFET 50 and MOSFET 52, and both are ultra-high voltage tolerable devices. As demonstrated in FIG. 4, the PWM controller die 36 includes a zener diode 54 and a current-limiting resistor 56. Inside the ultra-high voltage startup die 38, the drain and the source of JFET 50 are connected to the drain and the gate of MOSFET 52, respectively. The drain and the source of the MOSFET 52 are connected via bonding wires to pin UHV and a diode 57 in the PWM controller die 36. Via a control pad and at least one associated bonding wire, the gate of the MOSFET 52 is electrically connected to the zener diode in the PWM controller die 36. The zener diode 54 and the current-limiting resistor 56 function together as a voltage-clamping circuit to limit the maximum voltage on the control pad. In one embodiment, the threshold voltage for the JFET 50 is negative. During a startup procedure when the PWM controller die 36 keeps a power switch open, the JFET 50 conducts a relatively-small current to charge the gate of the MOSFET 52. When a gate-to-source voltage of the MOSFET 52 exceeds a threshold voltage, the MOSFET 52 conducts a relatively-large current to charge and build, via the diode 57, the operation power source V_{CC} on pin VCC. In the same time, the JFET 50 is turned off by itself because of body effect and the raised voltage at its source electrode. For example, the JFET 50 could be designed to be off if the gate voltage of the MOSFET 52 is equal to or exceeds 15V. In case that the threshold voltage of the MOSFET 52 is about 5V, the ultra-high voltage startup die 38 will charge the operation power source V_{CC} to be as high as 10V (15V-5V) during the startup procedure, after which a normal operation follows. During the normal operation, the PWM controller die 36 turns on and off a power switch, and the gate voltage of the MOSFET 52 and the operation power source V_{CC} are maintained to be higher than or equal to 15V and 10V, respectively. It can be derived that both the MOSFET 52 and the JFET 50 are in an off state during the normal operation, such that the ultra-high voltage startup die 38 performs an open-circuit, substantially consuming no electric current or power.

Following exemplifies some benefits introduced by the power controller 30 in FIG. 3.

1. Semiconductor manufacturing simplification: In light of semiconductor manufacturing process, the process flow for making the ultra-high voltage startup die 38 differs largely to that for making the PWM controller die 36, and they'd better be separately manufactured to enjoy optimized process recipes. Otherwise, if they are merged in one die, the high-temperature diffusion process needed for manufacturing ultra-high voltage devices, for example, will degrade the performance of the high voltage devices or enlarge the silicon area required for the high voltage devices. Individual and separated manufacturing processes for the PWM controller die 36 and the ultra-high voltage startup die 38 could realize compact die sizes and improved yields thereof, saving the silicon cost.

2. Noise isolation: In comparison with the single die in FIG. 2, the PWM controller die 36 and the ultra-high voltage startup die 38 are formed on two different and separated substrates. Therefore, the noise in one die that is unwelcome by analog circuits will not go to the other die via a common substrate. In case that some noise occurs to the substrate of the ultra-high voltage startup die 38 for example, it will be first conducted by the die paddle 32 to a ground, rather than disturbing the substrate of the PWM controller die 36.

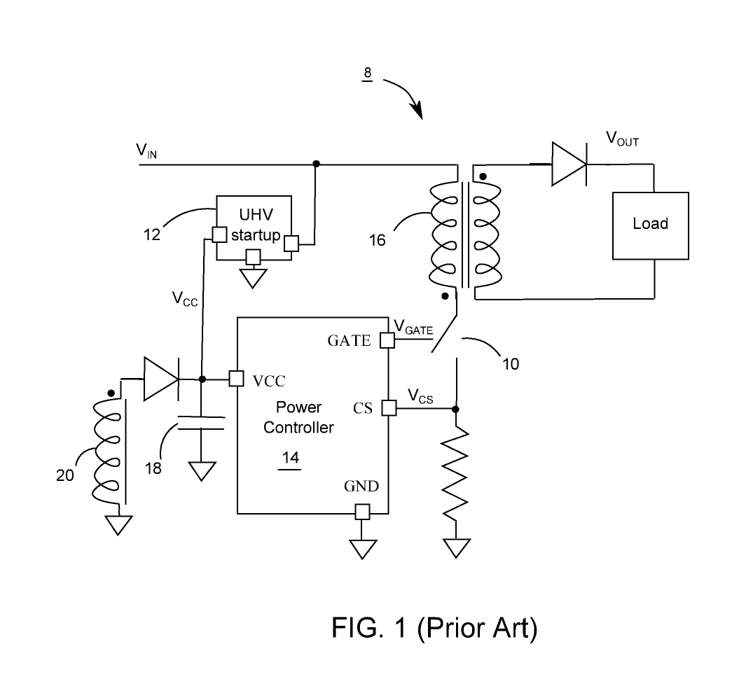

3. Component storage management: The PWM controller die 36 and the ultra-high voltage startup die 38 together are packaged in one single multi-chip module 33, to be the power controller 30 in FIG. 3. In appearance, the power controller 30 is a single packaged integrated circuit, just the same as the power controller 22 in FIG. 2. Unlike the switching mode power supply in FIG. 1 that has two components respectively functioning for pulse-width modulation and ultra-high voltage startup, a power converter system using the power controller 30 could enjoy low component count and easy storage management during manufacturing.

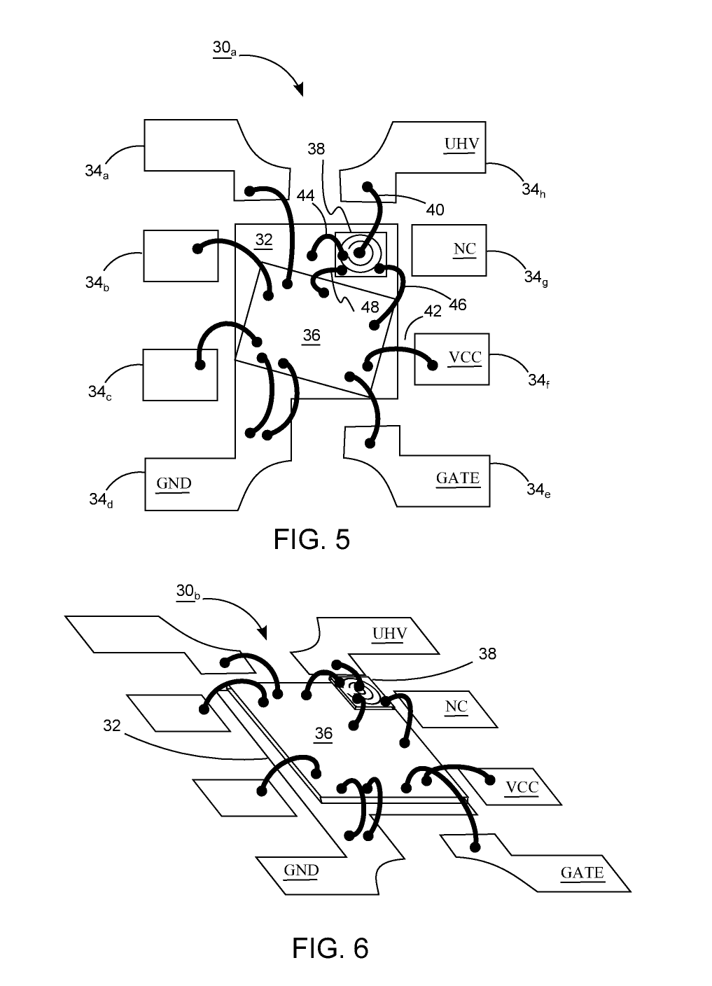

FIG. 5 demonstrates another power controller 30ₐ according to embodiments of the invention, where the PWM controller die 36 is positioned on the die paddle 32 in a tilted way that its edges are not parallel to the edges of the die paddle 32, while the edges of the ultra-high voltage startup die 38 are. The titled way is to make a larger space in the top-right corner of the die paddle 32, to hold the ultra-high voltage startup die 38 therein. This enlarged space can only be achieved when the PWM controller die 36 is separated from the ultra-high voltage startup die 38.

Shown in FIG. 6 is a power controller 30_{b}, which is a chip-stack package. The ultra-high voltage startup die 38 and the PWM controller die 36 are stacked sequentially on the die paddle 32 while bonding wires and some conductive material provide electrical interconnection. In FIG. 6, the ultra-high voltage startup die 38 are the topmost die, locating in the corner of a die paddle closest to pin UHV.

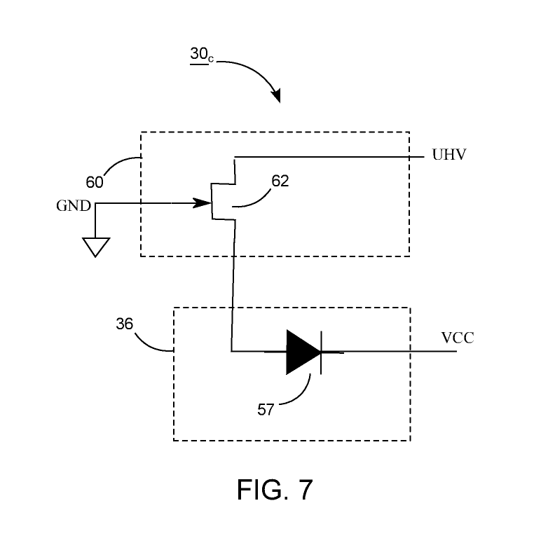

In one embodiment, an ultra-high voltage startup die substantially consists of a JFET and a MOSFET, as demonstrated in FIGS. 3 and 4. Of course, there must be several passive or parasitic devices, such as resistors or capacitors in the ultra-high voltage startup die 38, and they are not shown in FIGS. 3 and 4. In another embodiment, an ultra-high voltage startup die has no MOSFET and substantially consists of one or more JFETs. FIG. 7 demonstrates a power controller 30_{c}, where the PWM controller die 36 and the ultra-high voltage startup die 60 together are packaged in one single multi-chip module. The ultra-high voltage startup die 60 substantially has only one active device, JEFT 62, while passive devices in the ultra-high voltage startup die 60 are not shown. For example, JFET 62 is turned off by itself if a charging pad connecting the JFET 62 to the diode 57 has a voltage more than 11V. Demonstrated in FIG. 7, the ultra-high voltage startup die 60 only has three kinds of pads, consisting of ultra-high voltage pad, charging pad, and ground pad, respectively connected to ultra-high voltage input pin UHV, the diode 57 in the PWM controller die 36, and a ground voltage.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A power controller with ultra-high voltage startup, comprising:
a power controller die, operable to control a power switch when powered by an operation power source, wherein the operation power source has a maximum voltage limit of tens volt;
an ultra-high voltage startup die, comprising an ultra-high voltage pad tolerable to receiving an input line voltage higher than one hundred volt, wherein during a startup procedure the ultra-high voltage startup die charges the operation power source, and during a normal operation the ultra-high voltage startup die substantially performs an open-circuit; and
a multi-chip module, for packaging both the power controller die and the ultra-high voltage startup die.

2. The power controller as claimed in claim 1, wherein the ultra-high voltage startup die comprises at least one active device, and the active device is ultra-high voltage tolerable.

3. The power controller as claimed in claim 1, wherein the ultra-high voltage startup die substantially consists of a junction field effect transistor (JFET) and a metal-oxide-semiconductor (MOS) transistor.

4. The power controller as claimed in claim 1, wherein the ultra-high voltage startup die substantially consists of a junction field effect transistor (JFET).

5. The power controller as claimed in claim 1, wherein the multi-chip module comprises a lead frame with a die paddle, and both the power controller die and the ultra-high voltage startup die are stacked on the die paddle.

6. The power controller as claimed in claim 1, wherein the multi-chip module comprises a leadframe with a die paddle and several corner leads, the die paddle comprises corners, and the ultra-high voltage startup die is positioned on the die paddle in one of the corners closest to one of the corner leads and away from the other corners.

7. The power controller as claimed in claim 1, wherein the multi-chip module comprises a leadframe with a die paddle, and the power controller die and the ultra-high voltage startup die are separately positioned on the die paddle.

8. The power controller as claimed in claim 1, wherein the ultra-high voltage startup die comprises only three kinds of pads, consisting of ultra-high voltage pad, charging pad, and ground pad, the ultra-high voltage pad is connected to receive the input line voltage, the charging pad is electrically coupled to the operation power source by a first bonding wire, the ground pad is electrically connected to a ground pad in the power controller die.

9. The power controller as claimed in claim 1, wherein the ultra-high voltage startup die comprises only four kinds of pads, consisting of ultra-high voltage pad, charging pad, ground pad, and control pad, connected, through bonding wires, to the line input voltage, the operation power source, a ground voltage, and the power controller die, respectively.

10. The power controller as claimed in claim 9, wherein the power controller die has a voltage-clamping circuit to limit the maximum voltage on the control pad.

11. The power controller as claimed in claim 1, wherein the power controller die provides a pulse-width-modulation signal to control the power switch.

12. The power controller as claimed in claim 1, wherein the ultra-high voltage startup die comprises a ground pad that is electrically connected to a die paddle through a bonding wire.

13. The power controller as claimed in claim 1, wherein the power controller die comprises a diode via which the ultra-high voltage startup die charges the operation power source.

14. The power controller as claimed in claim 1, wherein the multi-chip module comprises a lead frame with a die paddle, and the power controller die is positioned on the die paddle in a tilted way that edges of the power controller die are not parallel to edges of the die paddle.
